(19) United States
(12) Patent Application Publication
(10) Pub. No.: US 2026/0295617 A1
(43) Pub. Date: Oct. 1, 2026

(54) ROBOT MONITORING DEVICE FOR COATING MACHINE, CONTROL DEVICE FOR ROBOT SYSTEM, AND CONTROL METHOD FOR ROBOT SYSTEM

(71) Applicant: KAWASAKI JUKOGYO KABUSHIKI KAISHA, Kobe-shi (JP)

(72) Inventors: Akira SHOJI, Kobe-shi (JP); Dai FUKUDA, Kobe-shi (JP); Yoshiki NAITO, Kobe-shi (JP)

(73) Assignee: KAWASAKI JUKOGYO KABUSHIKI KAISHA, Kobe-shi (JP)

(21) Appl. No.: 19/632,758

(22) Filed: Mar. 30, 2026

(30) Foreign Application Priority Data
Mar. 28, 2025 (JP) 2025-054936

(51) Int. Cl. B05B 12/00; B05B 5/04; B25J 11/00

(52) U.S. Cl. CPC B05B 12/004; B05B 5/0407; B25J 11/0075

(57) ABSTRACT

The monitoring device for a coating machine includes: a rotary atomizing coating machine that coats a workpiece by supplying paint to a bell cup through a feed tube while rotating the bell cup by an air motor, the bell cup being removably mounted on a distal end of a shaft of the air motor; an electro-pneumatic regulator that supplies air to the air motor; and a controller that outputs, to the electro-pneumatic regulator, a startup command to start the air motor, and detects that the bell cup is mounted on the shaft based on a specific parameter related to operation of the air motor during startup of the air motor.

### CROSS-REFERENCE TO RELATED APPLICATION

This application claims priority to Japanese Patent Application No. 2025-054936 filed on Mar. 28, 2025, the entire disclosure of which is incorporated herein by reference.

### BACKGROUND

The technology disclosed herein relates to monitoring devices for coating machines, control devices for robot systems, and control methods for robot systems.

A conventional condition determination device for a coating apparatus detects rotational runout of a rotary atomizing head rotated by an air motor by detecting vibration of the coating apparatus. The runout occurs in a case where the rotary atomizing head is mounted eccentrically relative to the shaft of the air motor. The rotary atomizing head is also referred to as a bell cup.

A rotary atomizing coating machine such as a conventional coating apparatus is, for example, supported by an arm of a robot and used to coat a workpiece.

### SUMMARY

Before the robot coats a workpiece, the amount of paint supplied to the coating machine may be checked as part of preparation. During this check, the operator confirms that the amount of paint corresponding to the instructed amount is discharged through the feed tube.

In a rotary atomizing coating machine, the bell cup is removable from a distal end of the shaft of the air motor. During this check, the operator removes the bell cup from the distal end of the shaft of the air motor and discharges paint without rotating the air motor.

If the air motor is rotated without the bell cup mounted, paint scatters. When paint is discharged with the bell cup mounted but without rotating the air motor, the paint impinges on the bell cup and flows back into the air motor.

By discharging paint with the bell cup removed and without rotating the air motor, the operator can accurately confirm the amount of paint discharged from the distal end of the feed tube.

After the check and before the robot coats the workpiece, the operator remounts the bell cup on the shaft of the air motor. If the air motor is rotated with the bell cup removed, paint scatters as described above, and the workpiece cannot be coated.

However, the operator may forget to remount the bell cup after the check.

At present, the operator visually confirms mounting of the bell cup for each robot to reduce the risk of forgetting to remount it. However, because the robots are installed in a hazardous area, the operator performs this check from outside the hazardous area. Performing this check from a position distant from the robot is difficult. In addition, depending on the installation position of the robot, the coating machine may not be readily visible from outside the hazardous area.

The technology disclosed herein relates to a monitoring device for a coating machine. The monitoring device includes: a rotary atomizing coating machine that coats a workpiece by supplying paint to a bell cup through a feed tube while rotating the bell cup by an air motor, the bell cup being removably mounted on a distal end of a shaft of the air motor; an electro-pneumatic regulator that supplies air to the air motor; and a controller that outputs, to the electro-pneumatic regulator, a startup command to start the air motor, and detects that the bell cup is mounted on the shaft based on a specific parameter related to operation of the air motor during startup of the air motor.

### BRIEF DESCRIPTION OF THE DRAWINGS

FIG. 1 is a block diagram of a control device for a robot system including a monitoring device for a coating machine.

FIG. 2 shows a control panel.

FIG. 3 is a sectional view of a rotary atomizing coating machine.

FIG. 4 is a graph showing how the rotational speed profile during air motor startup differs depending on whether the bell cup is mounted.

FIG. 5 is a flowchart showing a procedure for confirming mounting of the bell cup.

### DETAILED DESCRIPTION OF THE DRAWINGS

Embodiments of a monitoring device for a coating machine, a control device for a robot system, and a control method for a robot system will be described below with reference to the drawings. The monitoring device for a coating machine, the control device for a robot system, and the control method for a robot system described herein are merely examples.

### Overall Configuration of Robot System

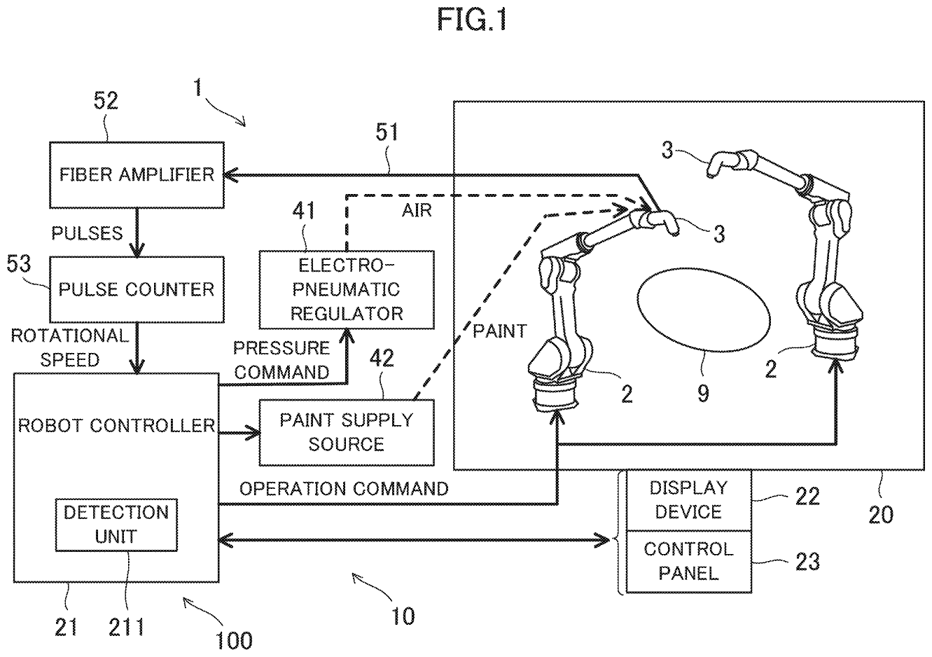

FIG. 1 shows a robot system 1. The robot system 1 is configured such that a robot 2 coats a workpiece 9. The robot system 1 includes the robot 2. The robot 2 need not be included in a monitoring device 10 for a coating machine 3.

The robot 2 is, for example, a vertically articulated robot. The robot 2 is not limited to a vertically articulated robot. The robot 2 may have any number of axes. The robot 2 may be, for example, a six-axis robot. The robot 2 includes an arm. The arm of the robot 2 supports the coating machine 3 described later.

The robot 2 is installed in an isolated hazardous area 20. Two or more robots 2 may be installed in the hazardous area 20. The robot 2 is fixed to a floor of the hazardous area 20, or is fixed to a wall of the hazardous area 20. The robot 2 may be installed so as to be movable within the hazardous area 20. The robot 2 has an explosion-proof structure.

The robot 2 can be used to coat various industrial products such as automobiles, aircraft, and railway vehicles. The workpiece 9 is not limited to automobiles, aircraft, and railway vehicles.

A robot controller 21 is connected to the robot 2 via a harness. The robot controller 21 is installed outside the hazardous area 20. The robot controller 21 outputs operation commands to the robot 2. The robot 2 operates in response to operation commands from the robot controller 21 and coats the workpiece 9. The robot 2 and the robot controller 21 together form a control device 100 for the robot system 1.

The robot controller 21 may be connected to one robot 2 and output operation commands to that robot 2. The robot controller 21 may be connected to two or more robots 2 and output operation commands to each of the robots 2.

A display device 22 and a control panel 23 are installed outside the hazardous area 20. The display device 22 is electrically connected to the robot controller 21. The display device 22 displays information in response to signals from the robot controller 21. The display device 22 need not be included in the monitoring device 10 for the coating machine 3 and the control device 100 for the robot system 1.

The control panel 23 is electrically connected to the robot controller 21. The control panel 23 need not be included in the monitoring device 10 for the coating machine 3.

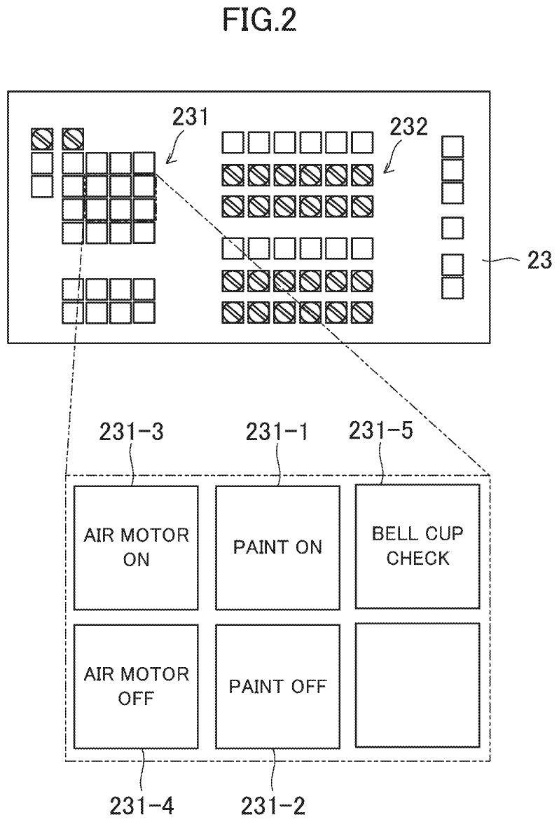

FIG. 2 illustrates the control panel 23. The control panel 23 includes pushbutton switches 231 and select switches 232. As shown enlarged in FIG. 2, the control panel 23 includes a “Paint ON” switch 231-1 for discharging paint from the coating machine 3 and a “Paint OFF” switch 231-2 for ending paint discharge. The control panel 23 further includes an “Air Motor ON” switch 231-3 for driving an air motor 31 of the coating machine 3 and an “Air Motor OFF” switch 231-4 for stopping the air motor 31.

The operator of the robot 2 views the display on the display device 22 and operates the pushbutton switches 231 and the select switches 232 on the control panel 23. The control panel 23 outputs, to the robot controller 21, an operation signal corresponding to the operator's operation. The robot controller 21 outputs, to the robot 2, an operation command corresponding to the operation signal.

### Configuration of Coating Machine

The robot system 1 includes the coating machine 3. The coating machine 3 is supported by the arm of the robot 2 as described above.

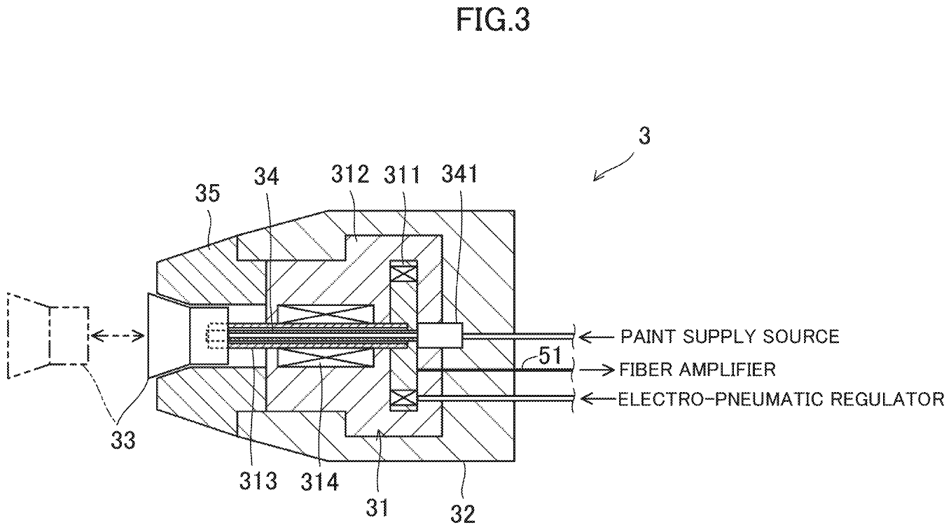

FIG. 3 shows the coating machine 3. The coating machine 3 is a rotary atomizing coating machine. The coating machine 3 includes the air motor 31. The air motor 31 is housed in a housing 32.

The air motor 31 includes a turbine 311. The turbine 311 is rotatably housed in a motor case 312. The turbine 311 rotates when air is supplied from an electro-pneumatic regulator 41 (see also FIG. 1). FIG. 1 is not intended to imply that the electro-pneumatic regulator 41 supplies air to the coating machine 3 of a single robot 2.

The air motor 31 includes a shaft 313. The shaft 313 is fixed to the turbine 311 and rotates together with the turbine 311. An air bearing 314 rotatably supports the shaft 313.

The coating machine 3 includes a bell cup 33. The bell cup 33 is mounted on a distal end of the shaft 313 of the air motor 31. The bell cup 33 is, for example, fastened to threads on the distal end of the shaft 313. As shown by long dashed double-short dashed lines in FIG. 3, the bell cup 33 is removably mounted on the distal end of the shaft 313. A cover 35 covers an opening at a distal end of the housing 32.

The bell cup 33 rotates together with the air motor 31. The rotating bell cup 33 centrifugally atomizes paint supplied through a feed tube 34 described later, and sprays the paint onto the workpiece 9.

The coating machine 3 includes the feed tube 34. The shaft 313 is hollow, and the feed tube 34 is located inside the shaft 313. A distal end of the feed tube 34 is connected to the bell cup 33. The feed tube 34 delivers paint to the bell cup 33.

A proximal end of the feed tube 34 is connected to a trigger valve 341. The trigger valve 341 switches between supplying paint to the feed tube 34 and stopping the supply of the paint. The trigger valve 341 is switched by air. As shown in FIG. 1, the trigger valve 341 is connected to a paint supply source 42. The paint supply source 42 supplies paint to the feed tube 34. FIG. 1 is not intended to imply that the paint supply source 42 supplies paint to the coating machine 3 of a single robot 2.

The configuration of the coating machine 3 in FIG. 3 is merely an example. The robot system 1 may employ coating machines of various known configurations.

An optical fiber 51 is connected to the coating machine 3. The optical fiber 51 is connected to an encoder that detects rotation of the air motor 31. As shown in FIG. 1, the optical fiber 51 sends to a fiber amplifier 52 an optical ON/OFF signal generated by the encoder. The fiber amplifier 52 receives the optical signal from the optical fiber 51 and outputs a pulse signal. FIG. 1 is not intended to imply that the optical fiber 51 is connected to the coating machine 3 of a single robot 2.

A pulse counter 53 counts pulses from the fiber amplifier 52 and converts the pulse count into the rotational speed of the air motor 31. The robot controller 21 acquires the rotational speed of the air motor 31 based on the output of the pulse counter 53.

Based on the acquired rotational speed of the air motor 31, the robot controller 21 adjusts the rotational speed of the air motor 31 to a target rotational speed by, for example, PI control. Specifically, the robot controller 21 outputs a pressure command to the electro-pneumatic regulator 41 so that the rotational speed of the air motor 31 reaches the target rotational speed. The electro-pneumatic regulator 41 adjusts the pressure of air supplied to the air motor 31 in response to the pressure command. By adjusting the air pressure, the rotational speed of the air motor 31 is adjusted.

### Confirmation of Mounting of Bell Cup

As described above, the bell cup 33 is removably mounted on the distal end of the shaft 313 of the air motor 31. The bell cup 33 may be removed from the coating machine 3 during preparation before the robot 2 coats the workpiece 9.

The operator removes the bell cup 33 from the coating machine 3 and, without rotating the air motor 31, operates the control panel 23 to cause the coating machine 3 to discharge paint. This operation is performed to confirm that the coating machine 3 discharges an amount of paint corresponding to the instructed amount. Since the air motor 31 is not rotated during this operation, paint does not scatter, and the operator can check the amount of paint discharged from the distal end of the feed tube 34. In addition, since the bell cup 33 is removed from the coating machine 3 during this checking operation, paint supplied through the feed tube 34 does not impinge on a non-rotating bell cup 33 and therefore does not flow back into the air motor 31.

Before the robot 2 starts coating the workpiece 9, the operator remounts the bell cup 33 on the distal end of the shaft 313 of the air motor 31. If paint is discharged by rotating the air motor 31 without the bell cup 33 mounted, the paint scatters, and the robot 2 and the coating machine 3 cannot coat the workpiece 9.

The robot system 1 disclosed herein can confirm that the bell cup 33 is mounted. The operator can confirm from outside the hazardous area 20 that the bell cup 33 is mounted.

The robot system 1 includes the monitoring device 10 for the coating machine 3. As shown in FIG. 1, the monitoring device 10 includes a detection unit 211. The detection unit 211 is a functional block in the robot controller 21. The detection unit 211 detects that the bell cup 33 is mounted based on the rotational speed profile of the air motor 31 during startup of the air motor 31 from a stopped state.

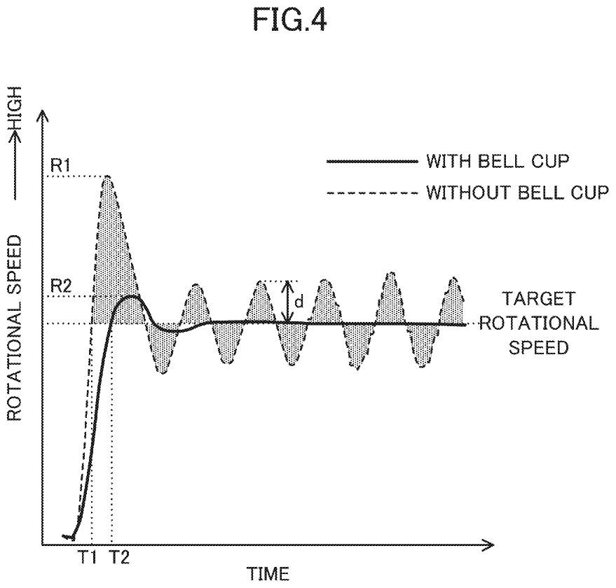

FIG. 4 shows how the rotational speed profile during startup of the air motor 31 differs depending on whether the bell cup 33 is mounted. In FIG. 4, the horizontal axis represents time, and the vertical axis represents the rotational speed of the air motor 31. As described above, the robot controller 21 can acquire the rotational speed of the air motor 31 from the output of the pulse counter 53.

The solid line in FIG. 4 shows the rotational speed profile of the air motor 31 with the bell cup 33 mounted on the shaft 313. After startup of the air motor 31, the rotational speed of the air motor 31 increases and overshoots the target rotational speed. Since the robot controller 21 performs feedback control of the air motor 31, the rotational speed of the air motor 31 subsequently converges promptly to the target rotational speed.

The dashed line in FIG. 4 shows the rotational speed profile of the air motor 31 with the bell cup 33 not mounted on the shaft 313. Because the bell cup 33 is not mounted, the rotating body, namely the air motor 31 without the bell cup 33, has a relatively small mass. After startup of the air motor 31, the rotational speed of the air motor 31 increases rapidly, resulting in a larger overshoot of the rotational speed. Furthermore, since the feedback gain is set based on the bell cup 33 being mounted on the air motor 31, the rotational speed of the air motor 31 does not readily converge to the target rotational speed.

As one example, the detection unit 211 detects that the bell cup 33 is mounted based on a comparison between measured times T1, T2 (T1<T2), which represent the time from startup of the air motor 31 until the rotational speed of the air motor 31 exceeds the target rotational speed, and a preset threshold time Tth. Specifically, in a case where the measured time is greater than the threshold time Tth, the detection unit 211 detects that the bell cup 33 is mounted on the air motor 31. In a case where the measured time is less than the threshold time Tth, the detection unit 211 detects that the bell cup 33 is not mounted on the air motor 31.

The monitoring device 10 for the coating machine 3 may check whether the bell cup 33 is mounted in response to an operation by the operator. For example, as shown in FIG. 2, when a “Bell Cup Check” push button 231-5 on the control panel 23 is operated, the monitoring device 10 checks whether the bell cup 33 is mounted. The monitoring device 10 starts the air motor 31 from a stopped state and detects mounting of the bell cup 33 based on the rotational speed profile of the air motor 31 during startup of the air motor 31.

The monitoring device 10 may automatically detect mounting of the bell cup 33 when the operator performs, on the control panel 23, an operation to prepare the robot 2 for operation. That is, the monitoring device 10 starts the air motor 31 from a stopped state and detects mounting of the bell cup 33 based on the rotational speed profile of the air motor 31 during startup of the air motor 31.

### Interlock Based on Bell Cup Mounting Status

The control device 100 for the robot system 1 includes interlocks that prohibit specific operations by the operator according to the monitoring result of the monitoring device 10 for the coating machine 3.

One interlock prohibits discharge of paint unless the air motor 31 is started in a case where it is detected that the bell cup 33 is mounted. This interlock reduces the risk of backflow of paint into the air motor 31 as described above.

Another interlock prohibits coating of the workpiece 9 by the robot 2 in a case where it is detected that the bell cup 33 is not mounted. This interlock reduces the risk of scattering of paint as described above.

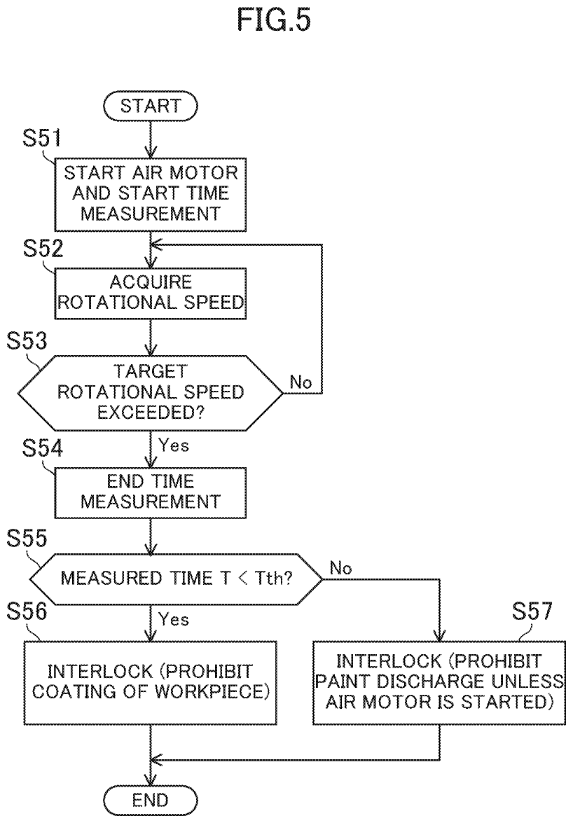

FIG. 5 is a flowchart illustrating a procedure for confirming mounting of the bell cup 33. As described above, the flow of FIG. 5 starts when the operator operates the “Bell Cup Check” push button 231-5 on the control panel 23 or when the operator performs, on the control panel 23, an operation to prepare the robot 2 for operation.

In step S51 after the start, the robot controller 21 starts the air motor 31 via the electro-pneumatic regulator 41. The robot controller 21 also measures the elapsed time from startup of the air motor 31.

Thereafter, in step S52, the robot controller 21 acquires, via the pulse counter 53, the rotational speed of the air motor 31 measured by the encoder.

In step S53, the robot controller 21 compares the rotational speed of the air motor 31 acquired in step S52 with the target rotational speed. The process of FIG. 5 repeats steps S52 and S53 until the rotational speed of the air motor 31 exceeds the target rotational speed.

When the rotational speed of the air motor 31 exceeds the target rotational speed, the robot controller 21 ends the time measurement in step S54, and then compares the measured time T with the predetermined threshold time Tth in step S55.

In a case where the measured time T is less than the threshold time Tth, the robot controller 21 detects that the bell cup 33 is not mounted on the air motor 31. In step S56, the robot controller 21 prohibits the robot 2 from coating the workpiece 9. Specifically, the robot controller 21 causes the display device 22 to display that the bell cup 33 is not mounted on the air motor 31. The operator can thus confirm from outside the hazardous area 20 that the bell cup 33 is not mounted.

In step S56, even when the operator issues a coating operation command for the robot 2 via the control panel 23, the robot controller 21 invalidates the command and prohibits the robot 2 from coating the workpiece 9.

In step S56, when the operator operates “Paint ON” without operating “Air Motor ON” on the control panel 23, the robot controller 21 enables the paint discharge command, and the coating machine 3 discharges paint. Accordingly, the operator can check the amount of paint discharged.

In step S55, in a case where the measured time T is greater than or equal to the threshold time Tth, the robot controller 21 detects that the bell cup 33 is mounted on the air motor 31. The robot controller 21 causes, for example, the display device 22 to display that the bell cup 33 is mounted on the air motor 31.

In step S57, unless the air motor 31 is started, the robot controller 21 prohibits the paint discharge operation. Even when the operator operates “Paint ON” without operating “Air Motor ON” on the control panel 23, the robot controller 21 invalidates the paint discharge command, and the coating machine 3 does not discharge paint. When the operator operates “Paint ON” after operating “Air Motor ON,” the robot controller 21 enables the paint discharge command, and the coating machine 3 discharges paint.

Further, in step S57, when the operator issues a coating operation command for the robot 2 via the control panel 23, the robot controller 21 enables the command and causes the robot 2 to perform the coating operation.

The flow shown in FIG. 5 is executed for the coating machines 3 of all robots 2 installed in the hazardous area 20.

### Functions and Effects

The monitoring device 10 for the coating machine 3 detects that the bell cup 33 is mounted on the shaft 313. The operator does not need to visually confirm mounting of the bell cup 33. By viewing the display on the display device 22, the operator can confirm from outside the hazardous area 20 that the bell cup 33 is mounted on the coating machine 3 supported by the robot 2. The operator can also confirm mounting of the bell cup 33 for each of the coating machines 3 of two or more robots 2.

The monitoring device 10 detects that the bell cup 33 is mounted based on a specific parameter related to the rotational speed during startup of the air motor 31. The monitoring device 10 can thus accurately detect mounting of the bell cup 33.

More specifically, during startup of the air motor 31, the monitoring device 10 detects that the bell cup 33 is mounted on the shaft 313 based on the time it takes for the rotational speed of the air motor 31 to reach the target rotational speed.

In a case where the bell cup 33 is mounted on the shaft 313 of the air motor 31, the rotating body that rotates together with the air motor 31 has a relatively large mass. In a case where the bell cup 33 is not mounted on the shaft 313 of the air motor 31, the rotating body that rotates together with the air motor 31 has a relatively small mass. Since the time it takes for the rotational speed of the air motor 31 to reach the target rotational speed during startup of the air motor 31 varies according to the mass of the rotating body, the monitoring device 10 can accurately detect mounting of the bell cup 33.

In the case where the bell cup 33 is mounted on the shaft 313, the control device 100 for the robot system 1 invalidates a paint discharge command issued via the control panel 23 while the air motor 31 is stopped. Such an interlock in the robot controller 21 can reduce the risk of backflow of paint.

In the case where the bell cup 33 is not mounted on the shaft 313, the control device 100 for the robot system 1 invalidates a coating operation command for the robot 2 issued via the control panel 23. Such an interlock in the robot controller 21 can reduce the risk of scattering of paint.

In the case where the bell cup 33 is not mounted on the shaft 313, the control device 100 for the robot system 1 allows a paint discharge command issued via the control panel 23 while the air motor 31 is stopped. The operator can perform a confirmation operation related to paint discharge, that is, an operation for confirming that an amount of paint corresponding to the instructed amount is discharged through the feed tube 34.

Since the control panel 23 includes the “Bell Cup Check” push button 231-5, the operator can manually start confirmation of mounting of the bell cup 33.

Further, the control device 100 for the robot system 1 detects mounting of the bell cup 33 when the operator performs, on the control panel 23, an operation to prepare the robot 2 for operation. Since mounting of the bell cup 33 can be automatically confirmed during preparation for operation of the robot 2, operator errors can be reduced.

### Modifications

Detection of mounting of the bell cup 33 by the detection unit 211 is not limited to the above-described method based on the time it takes for the rotational speed of the air motor 31 to exceed the target rotational speed, and various other detection methods may be employed.

As shown in FIG. 4, the detection unit 211 may detect that the bell cup 33 is mounted, for example, based on a comparison between overshoot amounts R1, R2 (R1>R2), which represent the amount by which the rotational speed of the air motor 31 exceeds the target rotational speed after startup of the air motor 31, and a preset threshold Rth. That is, in a case where the overshoot amount is smaller than the threshold Rth, the detection unit 211 detects that the bell cup 33 is mounted on the air motor 31. In a case where the overshoot amount is greater than the threshold Rth, the detection unit 211 detects that the bell cup 33 is not mounted on the air motor 31.

The detection unit 211 may detect that the bell cup 33 is mounted based on stabilization of the rotational speed of the air motor 31 at the target rotational speed. For example, in a case where, after a predetermined time has elapsed from startup of the air motor 31, the difference between the rotational speed of the air motor 31 and the target rotational speed (for example, see “d” in FIG. 4) is less than or equal to a predetermined value, the detection unit 211 detects that the bell cup 33 is mounted on the air motor 31. In a case where the difference between the rotational speed of the air motor 31 and the target rotational speed is greater than the predetermined value, the detection unit 211 detects that the bell cup 33 is not mounted on the air motor 31. The predetermined time from startup of the air motor 31 may be set based on the convergence time of the rotational speed under feedback control.

Stabilization of the rotational speed of the air motor 31 at the target rotational speed may be determined based on the integral of the absolute value of the difference between the rotational speed of the air motor 31 and the target rotational speed. The integral corresponds to the total area of the shaded portions in FIG. 4. In a case where the integral is less than or equal to a predetermined threshold, the detection unit 211 detects that the bell cup 33 is mounted on the air motor 31. In a case where the integral is greater than the predetermined threshold, the detection unit 211 detects that the bell cup 33 is not mounted on the air motor 31.

The detection unit 211 may detect mounting of the bell cup 33 based on a change in a pressure command output from the robot controller 21 to the electro-pneumatic regulator 41. The pressure command output from the robot controller 21 changes in response to fluctuations in rotational speed of the air motor 31. The manner in which the pressure command changes depending on whether the bell cup 33 is mounted corresponds to the rotational speed profile of the air motor 31 measured by the encoder shown in FIG. 4. The detection unit 211 can detect mounting of the bell cup 33 based on the pressure command output by the robot controller 21 using the various detection methods described above.

All of the detection methods described above are effective in a case where the robot controller 21 performs feedback control of the rotational speed of the air motor 31.

The detection unit 211 may detect mounting of the bell cup 33 even in a case where the robot controller 21 does not perform feedback control. For example, the electro-pneumatic regulator 41 may supply air to the air motor 31 at a predetermined constant pressure when the air motor 31 is started. The detection unit 211 may detect that the bell cup 33 is mounted on the shaft 313 based on the rotational speed of the air motor 31 after a predetermined time from startup of the air motor 31. In the case where the bell cup 33 is mounted, the rotating body has a relatively large mass, and therefore the rotational speed of the air motor 31 after the predetermined time from startup of the air motor 31 is relatively low. In the case where the bell cup 33 is not mounted, the rotating body has a relatively small mass, and therefore the rotational speed of the air motor 31 after the predetermined time from startup of the air motor 31 is relatively high. The detection unit 211 can accurately detect mounting of the bell cup 33.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality.

There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer-readable storage medium, a computer program product, a memory device, a record medium such as a CD-ROM or DVD, and/or the memory of FPGAs or ASICs.

### Aspects

The embodiment described above is a specific example of the following aspects.

### First Aspect

A monitoring device (10) for a coating machine (3) includes: a rotary atomizing coating machine (3) that coats a workpiece (9) by supplying paint to a bell cup (33) through a feed tube (34) while rotating the bell cup (33) by an air motor (31), the bell cup (33) being removably mounted on a distal end of a shaft (313) of the air motor (31); an electro-pneumatic regulator (41) that supplies air to the air motor (31); and a controller (21) that outputs, to the electro-pneumatic regulator (41), a startup command to start the air motor (31), and detects that the bell cup (33) is mounted on the shaft (313) based on a specific parameter related to operation of the air motor (31) during startup of the air motor (31).

The controller (21) detects that the bell cup (33) is mounted on the shaft (313).

Specifically, the controller (21) outputs, to the electro-pneumatic regulator (41), a startup command to start the air motor (31). Air is supplied to the air motor (31), and the air motor (31) is started.

The controller (21) detects that the bell cup (33) is mounted on the shaft (313) based on a specific parameter related to operation of the air motor (31) during startup. The monitoring device (10) for the coating machine (3) can accurately detect that the bell cup (33) is mounted on the shaft (313).

### Second Aspect

The monitoring device (10) of the first aspect further includes: a sensor (51, 52, 53) that measures a rotational speed of the air motor (31). The electro-pneumatic regulator (41) adjusts, based on the rotational speed of the air motor (31) measured by the sensor (51, 52, 53), supply of air to the air motor (31) such that the rotational speed of the air motor (31) becomes a target rotational speed. The controller (21) detects that the bell cup (33) is mounted on the shaft (313) based on the rotational speed of the air motor (31) measured by the sensor (51, 52, 53).

Since the mass of the rotating body including the air motor (31) varies depending on whether the bell cup (33) is mounted, the rotational speed profile of the air motor (31) during startup of the air motor (31) differs depending on whether the bell cup (33) is mounted.

The monitoring device (10) for the coating machine (3) can accurately detect that the bell cup (33) is mounted on the shaft (313) based on the rotational speed of the air motor (31).

### Third Aspect

In the monitoring device (10) of the second aspect, the controller (21) detects that the bell cup (33) is mounted on the shaft (313) based on a time until the rotational speed of the air motor (31) reaches the target rotational speed during startup of the air motor (31).

In the case where the bell cup (33) is mounted on the shaft (313) of the air motor (31), the rotating body that rotates together with the air motor (31) has a relatively large mass, and it takes a long time until the rotational speed of the air motor (31) reaches the target rotational speed during startup of the air motor (31).

In the case where the bell cup (33) is not mounted on the shaft (313), the rotating body that rotates together with the air motor (31) has a relatively small mass, and the rotational speed of the air motor (31) reaches the target rotational speed in a short time during startup of the air motor (31).

The controller (21) can accurately detect that the bell cup (33) is mounted on the shaft (313) based on the time until the rotational speed of the air motor (31) reaches the target rotational speed.

### Fourth Aspect

In the monitoring device (10) of the second aspect, the controller (21) detects that the bell cup (33) is mounted on the shaft (313) based on an overshoot amount by which the rotational speed of the air motor (31) exceeds the target rotational speed during startup of the air motor (31).

In the case where the bell cup (33) is mounted on the shaft (313), the rotating body that rotates together with the air motor (31) has a relatively large mass. Therefore, the overshoot amount during startup of the motor (31) is small.

In the case where the bell cup (33) is not mounted on the shaft (313), the rotating body that rotates together with the air motor (31) has a relatively small mass. Therefore, the overshoot amount during startup of the motor (31) is large.

The controller (21) can accurately detect that the bell cup (33) is mounted on the shaft (313) based on the overshoot amount during startup of the air motor (31).

### Fifth Aspect

In the monitoring device (10) of the second aspect, the controller (21) performs feedback control of the rotational speed of the air motor (31) based on the rotational speed of the air motor (31) measured by the sensor (51, 52, 53), and the controller (21) detects that the bell cup (33) is mounted on the shaft (313) based on stabilization of the rotational speed of the air motor (31) at the target rotational speed.

In the feedback control of the rotational speed of the air motor (31), a feedback gain is set based on the bell cup (33) being mounted on the shaft (313).

In the case where the bell cup (33) is mounted on the shaft (313), the rotational speed of the air motor (31) promptly converges to the target rotational speed after startup of the air motor (31) and stabilizes under the feedback control by the controller (21). The rotational speed of the air motor (31) may be regarded as stabilizing at the target rotational speed in a case where, after a predetermined time from startup of the air motor (31), the difference between the rotational speed of the air motor (31) and the target rotational speed is less than or equal to a predetermined value.

In the case where the bell cup (33) is not mounted on the shaft (313), the rotating body that rotates together with the air motor (31) has a relatively small mass. Accordingly, the rotational speed of the air motor (31) does not stabilize at the target rotational speed even after time has elapsed from startup of the air motor (31). That is, even after the predetermined time from startup of the air motor (31), the difference between the rotational speed of the air motor (31) and the target rotational speed is greater than the predetermined value.

The controller (21) can accurately detect that the bell cup (33) is mounted on the shaft (313) based on stabilization of the rotational speed of the air motor (31) at the target rotational speed.

### Sixth Aspect

In the monitoring device (10) of the fifth aspect, the controller (21) detects that the bell cup (33) is mounted on the shaft (313) based on an integral of an absolute value of a difference between the rotational speed of the air motor (31) and the target rotational speed during startup of the air motor (31).

In a case where the rotational speed of the air motor (31) converges to the target rotational speed, the integral of the absolute value of the difference between the rotational speed of the air motor (31) and the target rotational speed is small. In a case where the integral is less than or equal to a predetermined value, the controller (21) can detect that the bell cup (33) is mounted on the shaft (313).

In a case where the rotational speed of the air motor (31) does not converge to the target rotational speed, the integral of the absolute value of the difference between the rotational speed of the air motor (31) and the target rotational speed is large. In a case where the integral is greater than the predetermined value, the controller (21) can detect that the bell cup (33) is not mounted on the shaft (313).

### Seventh Aspect

In the monitoring device (10) of the second aspect, the electro-pneumatic regulator (41) supplies air to the air motor (31) at a predetermined constant pressure during startup of the air motor (31), and the controller (21) detects that the bell cup (33) is mounted on the shaft (313) based on the rotational speed of the air motor (31) after a predetermined time from startup of the air motor (31).

In the case where the bell cup (33) is mounted on the shaft (313), the rotating body that rotates together with the air motor (31) has a relatively large mass, and therefore the rotational speed increases at a low rate during startup of the air motor (31). In a case where the controller (21) supplies air to the air motor (31) at the predetermined constant pressure instead of performing feedback control, the rotational speed of the air motor (31) after the predetermined time from startup of the air motor (31) is low.

In the case where the bell cup (33) is not mounted on the shaft (313), the rotating body that rotates together with the air motor (31) has a relatively small mass, and therefore the rotational speed increases at a high rate during startup of the air motor (31). That is, in the case where the controller (21) supplies air to the air motor (31) at the predetermined constant pressure, the rotational speed of the air motor (31) after the predetermined time from startup of the air motor (31) is high.

The controller (21) can accurately detect that the bell cup (33) is mounted on the shaft (313) based on the rotational speed of the air motor (31) after the predetermined time from startup of the air motor (31).

### Eighth Aspect

In the monitoring device (10) of any one of the first to seventh aspects, the rotary atomizing coating machine (3) is supported by an arm of a robot (2).

The robot (2) may be installed in a hazardous area. The monitoring device (10) for the coating machine (3) described above enables an operator to confirm, from outside the hazardous area, whether the bell cup (33) is mounted on the coating machine (3) supported by the robot (2).

### Ninth Aspect

A control device (100) for a robot system (1) includes: a robot (2); a rotary atomizing coating machine (3) that is supported by an arm of the robot (2) and that coats a workpiece (9) by supplying paint to a bell cup (33) through a feed tube (34) while rotating the bell cup (33) by an air motor (31), the bell cup (33) being removably mounted on a distal end of a shaft (313) of the air motor (31); an electro-pneumatic regulator (41) that supplies air to the air motor (31); a controller (21) that outputs, to the electro-pneumatic regulator (41), a startup command to start the air motor (31), and detects that the bell cup (33) is mounted on the shaft (313) based on a specific parameter related to operation of the air motor (31) during startup of the air motor (31); and a control panel (23) that outputs, to the controller (21), an operation command to operate the robot (2) and the rotary atomizing coating machine (3) in response to an operation by an operator. In the case where the bell cup (33) is mounted on the shaft (313), the controller (21) invalidates a paint discharge command issued via the control panel (23) while the air motor (31) is stopped.

As described above, the controller (21) detects that the bell cup (33) is mounted on the shaft (313) based on the specific parameter related to operation of the air motor (31) during startup of the air motor (31).

In the case where the bell cup (33) is mounted on the shaft (313), if paint is supplied to the bell cup (33) through the feed tube (34) while the air motor (31) is stopped, the paint may impinge on the bell cup (33) and flow back into the air motor (31).

The controller (21) invalidates a paint discharge command issued via the control panel (23) while the air motor (31) is stopped. Such an interlock in the controller (21) can reduce the risk of backflow of paint.

### Tenth Aspect

In the control device (100) of the ninth aspect, in the case where the bell cup (33) is not mounted on the shaft (313), the controller (21) invalidates a coating operation command for the robot (2) issued via the control panel (23).

In the case where the bell cup (33) is not mounted on the shaft (313), if paint is supplied through the feed tube (34) while rotating the air motor (31), the paint scatters, and the coating machine (3) cannot coat the workpiece (9).

The controller (21) invalidates a coating operation command for the robot (2) issued via the control panel (23). Such an interlock in the controller (21) can reduce the risk of scattering of paint.

In the case where the bell cup (33) is not mounted on the shaft (313), the controller (21) allows a paint discharge command issued via the control panel (23) while the air motor (31) is stopped. Since the air motor (31) is stopped, the paint does not scatter. Furthermore, since the bell cup (33) is not mounted on the shaft (313), the paint does not flow back. Based on the amount of paint discharged from the feed tube (34), the operator can confirm that the coating machine (3) discharges an amount of paint corresponding to the instructed amount.

### Eleventh Aspect

In the control device (100) of the ninth or tenth aspect, the controller (21) detects mounting of the bell cup (33) when an operation to execute a bell cup mounting check is performed on the control panel (23).

That is, the operator may manually instruct to execute the bell cup mounting check.

### Twelfth Aspect

In the control device (100) of the ninth or tenth aspect, the controller (21) detects mounting of the bell cup (33) when an operation to prepare the robot (2) for operation is performed on the control panel (23).

That is, when the operator performs an operation to prepare the robot (2) for operation, the controller (21) may automatically detect mounting of the bell cup (33). This configuration can reduce operator errors, such as instructing the robot (2) to perform a coating operation while the bell cup (33) is not mounted.

### Thirteenth Aspect

A control method for a robot system (1) includes: starting an air motor (31) of a rotary atomizing coating machine (3) by supplying air to the air motor (31) by an electro-pneumatic regulator (41), the rotary atomizing coating machine (3) being supported by a robot (2); detecting, by a controller (21), that a bell cup (33) is mounted on the air motor (31) based on a specific parameter related to operation of the air motor (31) during startup of the air motor (31); in the case where the bell cup (33) is not mounted on the air motor (31), enabling, by the controller (21), a paint discharge command issued via a control panel (23) while the air motor (31) is stopped; and in the case where the bell cup (33) is mounted on the air motor (31), invalidating, by the controller (21), the paint discharge command issued via the control panel (23) while the air motor (31) is stopped.

After the operator removes the bell cup (33) from the air motor (31), and while the air motor (31) is stopped, the operator issues a paint discharge command. Since paint is discharged from the feed tube (34), the operator can confirm that the coating machine (3) discharges an amount of paint corresponding to the instructed amount.

Even if the operator issues a paint discharge command while the bell cup (33) is mounted on the air motor (31) and the air motor (31) is stopped, paint is not discharged from the feed tube (34). This configuration can reduce the risk of backflow of paint.

### Fourteenth Aspect

The control method of the thirteenth aspect further includes, in the case where the bell cup (33) is not mounted on the air motor (31), invalidating, by the controller (21), a coating operation command for the robot (2) issued via the control panel (23).

In the case where the bell cup (33) is not mounted on the shaft (313), the coating machine (3) cannot coat the workpiece (9). Such an interlock in the controller (21) can reduce the risk of scattering of paint.

What is claimed is:

1. A monitoring device for a coating machine, the monitoring device comprising:
a rotary atomizing coating machine that coats a workpiece by supplying paint to a bell cup through a feed tube while rotating the bell cup by an air motor, the bell cup being removably mounted on a distal end of a shaft of the air motor;
an electro-pneumatic regulator that supplies air to the air motor; and
a controller that outputs, to the electro-pneumatic regulator, a startup command to start the air motor, and detects that the bell cup is mounted on the shaft based on a specific parameter related to operation of the air motor during startup of the air motor.

2. The monitoring device of claim 1, further comprising:
a sensor that measures a rotational speed of the air motor, wherein
the electro-pneumatic regulator adjusts, based on the rotational speed of the air motor measured by the sensor, supply of air to the air motor such that the rotational speed of the air motor becomes a target rotational speed, and
the controller detects that the bell cup is mounted on the shaft based on the rotational speed of the air motor measured by the sensor.

3. The monitoring device of claim 2, wherein
the controller detects that the bell cup is mounted on the shaft based on a time until the rotational speed of the air motor reaches the target rotational speed during startup of the air motor.

4. The monitoring device of claim 2, wherein
the controller detects that the bell cup is mounted on the shaft based on an overshoot amount by which the rotational speed of the air motor exceeds the target rotational speed during startup of the air motor.

5. The monitoring device of claim 2, wherein
the controller performs feedback control of the rotational speed of the air motor based on the rotational speed of the air motor measured by the sensor, and
the controller detects that the bell cup is mounted on the shaft based on stabilization of the rotational speed of the air motor at the target rotational speed.

6. The monitoring device of claim 5, wherein
the controller detects that the bell cup is mounted on the shaft based on an integral of an absolute value of a difference between the rotational speed of the air motor and the target rotational speed during startup of the air motor.

7. The monitoring device of claim 2, wherein
the electro-pneumatic regulator supplies air to the air motor at a predetermined constant pressure during startup of the air motor, and
the controller detects that the bell cup is mounted on the shaft based on the rotational speed of the air motor after a predetermined time from startup of the air motor.

8. The monitoring device of claim 1, wherein
the rotary atomizing coating machine is supported by an arm of a robot.

9. A control device for a robot system, comprising:
a robot;
a rotary atomizing coating machine that is supported by an arm of the robot and that coats a workpiece by supplying paint to a bell cup through a feed tube while rotating the bell cup by an air motor, the bell cup being removably mounted on a distal end of a shaft of the air motor;
an electro-pneumatic regulator that supplies air to the air motor;
a controller that outputs, to the electro-pneumatic regulator, a startup command to start the air motor, and detects that the bell cup is mounted on the shaft based on a specific parameter related to operation of the air motor during startup of the air motor; and
a control panel that outputs, to the controller, an operation command to operate the robot and the rotary atomizing coating machine in response to an operation by an operator, wherein
in a case where the bell cup is mounted on the shaft, the controller invalidates a paint discharge command issued via the control panel while the air motor is stopped.

10. The control device of claim 9, wherein
in a case where the bell cup is not mounted on the shaft, the controller invalidates a coating operation command for the robot issued via the control panel.

11. The control device of claim 9, wherein
the controller detects mounting of the bell cup when an operation to execute a bell cup mounting check is performed on the control panel.

12. The control device of claim 9, wherein
the controller detects mounting of the bell cup when an operation to prepare the robot for operation is performed on the control panel.

13. A control method for a robot system, the control method comprising:
starting an air motor of a rotary atomizing coating machine by supplying air to the air motor by an electro-pneumatic regulator, the rotary atomizing coating machine being supported by a robot;
detecting, by a controller, that a bell cup is mounted on the air motor based on a specific parameter related to operation of the air motor during startup of the air motor;
in a case where the bell cup is not mounted on the air motor, enabling, by the controller, a paint discharge command issued via a control panel while the air motor is stopped; and
in a case where the bell cup is mounted on the air motor, invalidating, by the controller, the paint discharge command issued via the control panel while the air motor is stopped.

14. The control method of claim 13, further comprising
in the case where the bell cup is not mounted on the air motor, invalidating, by the controller, a coating operation command for the robot issued via the control panel.
